(19) United States
(12) Patent Application Publication
(10) Pub. No.: US 2009/0199134 A1
(43) Pub. Date: Aug. 6, 2009

(54) MOBILE COMMUNICATION APPARATUS

(75) Inventor: Hirokazu MURAYAMA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/126,007

(22) Filed: May 23, 2008

(30) Foreign Application Priority Data
Jan. 31, 2008 (JP) P2008-021982

(51) Int. Cl. G06F 3/048

(52) U.S. Cl. 715/835

(57) ABSTRACT

According to one embodiment, a mobile communication apparatus includes: a display unit that displays a menu screen on which a plurality of icons are arranged as cells in a matrix; an input unit configured to operate a cursor for selecting at least one of the icons; a storage unit that stores priority levels of respective cells, the priority levels indicating priority for assigning the icons into the cells; and a control unit that re-assigns the icons to the cells in order of the priority levels according to the number of selecting operations for the respective icons.

### CROSS-REFERENCE TO RELATED APPLICATIONS

This application is based upon and claims the benefit of priority from Japanese Patent Application No. 2008-021982, filed Jan. 31, 2008, the entire contents of which are incorporated herein by reference.

### BACKGROUND

1. Field

One embodiment of the invention relates to a mobile communication apparatus for displaying a menu screen having a matrix shape.

2. Description of the Related Art

Among mobile communication apparatuses such as cell phones and PDAs (Personal Digital Assistants), some mobile communication apparatuses have menu screen displays in order to initiate setting operations of terminals and mounted functions without requiring complex operations. That is, while various functions are displayed in a list form as function icons, such a function which is desirably initiated is selected from these function icons, so that the selected function can be executed.

Conventionally, there is an information processing apparatus, in which as a display method of this menu screen, the menu screen is constructed in a one longitudinal column having a list shape, while use times of respective functions formed in the list shape is stored. Furthermore, there is another information processing apparatus in which arranging positions of the respective functions are changed at an upper portion of a list-shaped menu screen in this order from larger use times in response to use times of these functions (for instance, JP-A-2002-101181).

However, in the invention related to the JP-A-2002-101181, the inventive idea thereof may be merely applied only to such an information processing apparatus that the menu screen is constructed in the list shape, and can be hardly applied to another menu screen in which function icons are arranged in a matrix form where a plurality of these function icons are arranged along a longitudinal direction and a lateral direction. Also, although the functions whose use frequencies are high are arranged at the upper portion of the menu screen in the invention related to the above-described JP-A-2002-101181, the below-mentioned problem is present: That is, such a function icon arrangement that the functions whose use frequencies are high are arranged at the upper portion of the menu screen does not always give easily usable conditions due to user's favorable arms and other environments. As a consequence, on such a menu screen where the plurality of function icons are arranged along the lateral and longitudinal directions in the matrix form, in order to arrange function icons at user's desirable positions, the users are required to manually set the arrangements of the desirable function icons. Accordingly, there is such a situation that the users require inconvenient setting operations.

### SUMMARY

According to one aspect of the invention, there is provided a mobile communication apparatus including: a display unit that displays a menu screen on which a plurality of icons are arranged as cells in a matrix; an input unit configured to operate a cursor for selecting at least one of the icons; a storage unit that stores priority levels of respective cells, the priority levels indicating priority for assigning the icons into the cells; and a control unit that re-assigns the icons to the cells in order of the priority levels according to the number of selecting operations for the respective icons.

According to another aspect of the invention, there is provided a mobile communication apparatus including: a display unit that displays a menu screen on which a plurality of icons are arranged as cells in a matrix; an input unit configured to operate a cursor for selecting at least one of the icons; a storage unit that stores priority levels of respective cells, the priority levels indicating priority for assigning each icon and the priority levels allowing an identical priority level to two or more of the cells; and a control unit configured to sort the icons in order of the number of operations for selecting the icons to re-assign the icons to the cells in accordance with the priority levels of the cells, wherein the control unit rearranges positions of the icons that are re-assigned to the cells having different priority from the cells previously assigned.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary outer appearance view of a cell phone of an embodiment.

FIG. 2 is an exemplary block diagram for showing an internal arrangement of the cell phone of an embodiment.

FIG. 3 is an exemplary diagram for representing an arranging example of function icons and a setting example of priority levels of cells of an embodiment.

FIG. 4 is an exemplary flow chart for setting the priority levels of the cells of an embodiment.

FIG. 5 is an exemplary transition diagram as to re-arrangements of the function icons on the menu screen of an embodiment.

FIG. 6 is an exemplary flow chart for describing control operations of the menu screen of an embodiment.

### DETAILED DESCRIPTION

Referring now to drawings, a description is made of embodiments of the present invention.

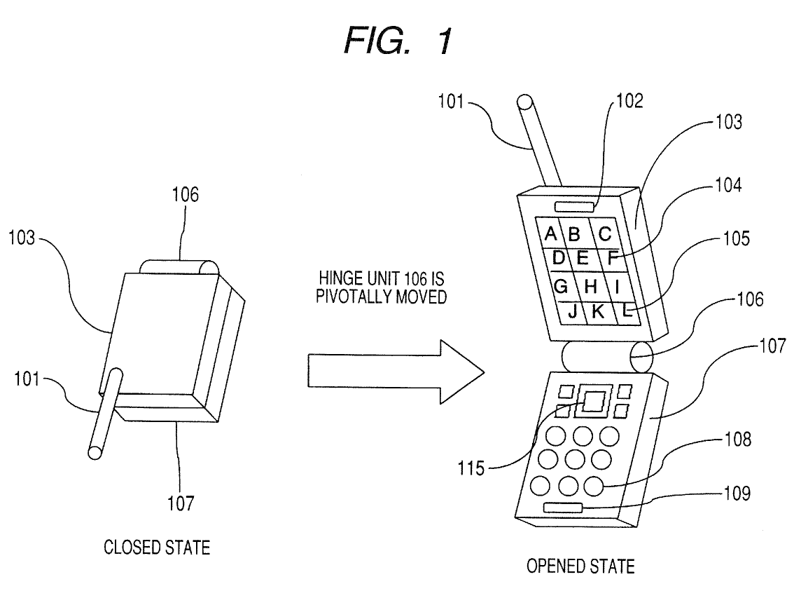

FIG. 1 is a diagram for showing an outer appearance of a folding type cell phone to which the present invention is applied. FIG. 1 shows an opened condition and a closed condition of an upper hosing 103 and a lower housing 107 of the folding type cell phone, respectively. The upper housing 103 is coupled to the lower housing 107 by a hinge portion 106 in a freely openable and closable manner. It should be understood that the shape of the cell phone is not limited only to the above-described folding type as shown in the present embodiment.

A display unit 105 is provided inside the upper housing 103. A matrix-shaped menu screen 104 is displayed on the display unit 105. In the matrix-shaped menu screen 104, a plurality of function icons are arranged along a longitudinal direction and a lateral direction, while these plural function icons may initiate normal telephone numbers, electronic mails, and various sorts of functions provided in the cell phone according to the present invention. A printed circuit board is provided inside the lower housing 107, on which a wireless transmitter/receiver, a display control unit, a voice processing unit an image processing unit, a memory, a CPU, and the like are mounted. Furthermore, a keyboard 108 having various sorts of keys is provided on the lower housing 107.

An antenna 101 used in a wireless communication and a speaker 102 which is employed so as to receive a telephone communication are installed on an outer plane of the upper housing 103. Furthermore, a microphone 109 employed so as to transmit a telephone communication and to input voice of a user is installed on the lower housing 107. In the display unit 105, for instance, a liquid crystal display LCD, an organic EL (electroluminescence), or the like is employed. On the keyboard 108, a move key 115, function keys such as a power supply key, and the like are provided in addition to data keys for entering numerals, characters, symbols, and the like. The move key 115 is employed so as to move a selection cursor displayed on the display unit 105.

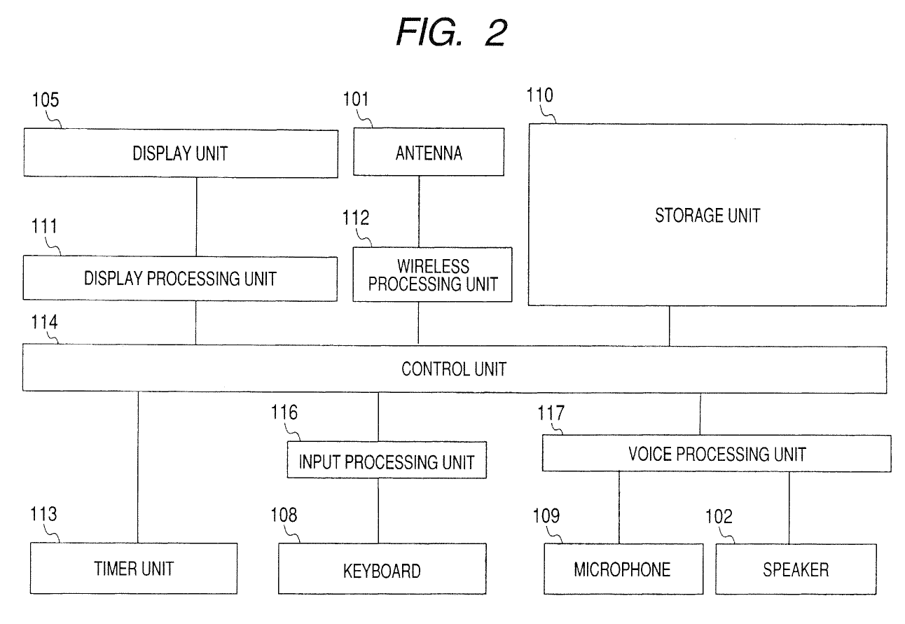

FIG. 2 is a block diagram for indicating an internal arrangement of the above-described cell phone.

The cell phone is equipped with an antenna 101, a wireless processing unit 112, a speaker 102, a microphone 109, and a voice processing unit 117. The antenna 101 is communicated with a base station (not shown) in a wireless manner. The wireless processing unit 112 receives a signal received by the antenna 101 so as to supply the received signal to a control unit 114, and transmits a signal received from the control unit 114 to the antenna 101. The speaker 102 is employed so as to receive a telephone communication. The microphone 108 inputs thereinto voice by a user. The voice processing unit 115 receives a voice signal inputted by the microphone 109 so as to transmit the received voice signal to the control unit 114, or outputs a voice signal received by the antenna 101 via the wireless processing unit 112 and the control unit 114 to the speaker 102.

Also, the cell phone is equipped with a storage unit 110 which stores thereinto at least use times of function icons to be displayed on the menu screen 104; priority levels of cells of a menu screen, which are arranged in a matrix form; an arrangement of the function icons; priority levels of cells where the respective function icons are arranged; times for re-arranging the arrangements of the function icons; various sorts of data folders; and the like. Further, the cell phone is equipped with a timer unit 113, a display processing unit 111, and a display unit 105. The timer unit 113 counts a time instant so as to output the counted time instant to the control unit 114. The display processing unit 105 receives information entered from the keyboard 108 and information received from the antenna 101 via the control unit 114 and, then, transmits the received information to the display unit 105. The display unit 105 displays thereon the information received from the display processing unit 111 in a visible manner.

Also, the cell phone is equipped with an input processing unit 111. The input processing unit 111 transmits information inputted from the keyboard 108 to the control unit 114. It should be understood that the control unit 114 is connected to at least the display processing unit 111, the timer unit 113, the input processing unit 116, the voice processing unit 117, the wireless processing unit 112, and the storage unit 110, so as to control the entire system of the cell phone.

Next, a description is made of a method for displaying function icons based upon process operations executed by the display unit 105, the storage unit 110, and the control unit 114, which are constructed in the above-described manner. In accordance with the present invention, while a plurality of function icons are arranged in a matrix, with respect to an arrangement of the function icons, a layout thereof is changed based upon use times of the function icons made by a user and priority levels of cells which are employed for arranging the function icons. As a result, such function icons whose use times are larger can be arranged at such positions that the arranged function icons can be easily used by the user.

Firstly, on the menu screen 104 displayed on the display unit 105 of the cell phone to which the present invention is applied, the function icons capable of initiating various sorts of functions are arranged in a matrix form. For example, it is so assumed that this matrix is constructed by employing 12 sections in total, namely, 4 sections are arrayed along a longitudinal direction of the matrix, whereas 3 sections are arrayed along a lateral direction thereof. A function icon displayed on the above-described menu screen 104 is selected by manipulating a selection cursor so as to initiate a desirable function. The selection cursor is moved along the cells by operating the move key 115. A use time during which a function icon is selected so as to initiate a desirable function in accordance with an instruction of the control unit 114 is stored every function icon in the storage unit 110. Further, the storage unit 110 previously store thereinto priority levels indicative of priority orders which are employed in order to set the function icons of the cells arranged in the matrix. The control unit 114 arranges function icons in response to use times and priority levels as to cells of the menu screen 104.

For instance, when the cell phone is used for a predetermined time period, use times as to the respective function icons are fluctuated; a use time as to such a function icon which is used by a user in the highest frequency becomes large, and thus, is re-arranged at a cell having the highest priority level, which is set by either the user or the control unit 114. Also, a function icon whose use time made by the user is the second largest use time is re-arranged to a cell having the second highest priority level. Moreover, a function icon whose use time made by the user is the third largest use time is re-arranged to a cell having the third highest priority level. As a consequence, the function icons which are used by the user many times can be arranged to such cells which can be readily operated by the user, so that the user can more easily execute the menu selecting operation.

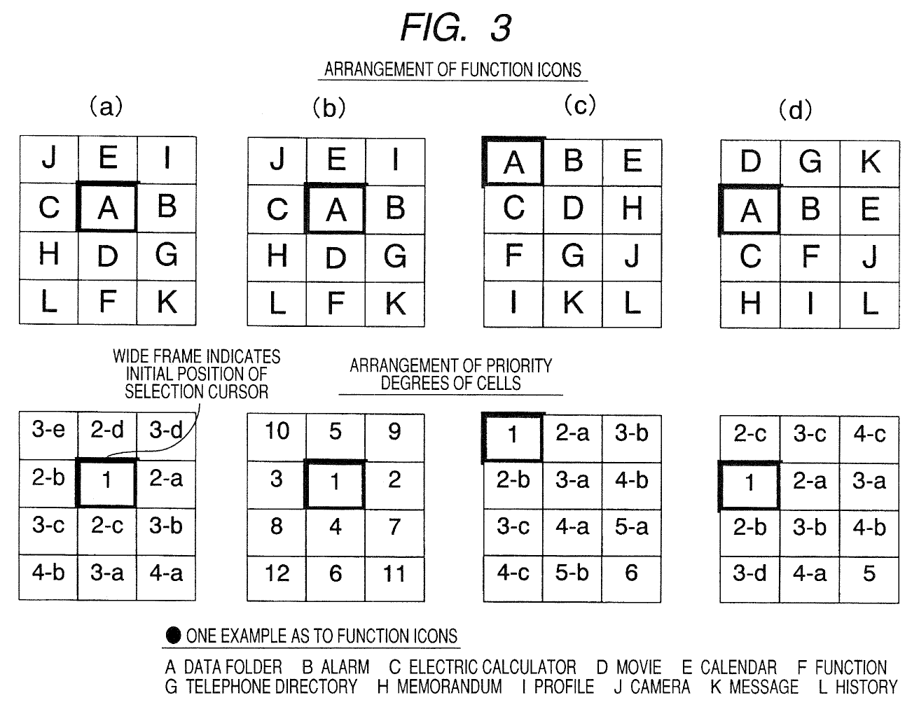

FIG. 3 is a diagram for representing 4 examples as to arrangements of priority levels as to cells of a menu screen, and arrangements of function icons, while the menu screen is constructed of 4 cells along a longitudinal direction of this menu screen and 3 cells along a lateral direction thereof. In FIG. 3(a) to FIG. 3(d), the lower diagrams show the priority levels of the respective cells of the menu screen constituted by 4×3 cells, whereas upper diagrams indicate function icons (A) to (L) which are arranged in accordance with the priority levels thereof.

In this embodiment, as one example of the function icons, the following symbols are assumed as follows:

(A) indicates a data folder; (B) shows an alarm; (C) represents an electric calculator; (D) indicates a movie; (E) shows a calendar; (F) represents a function; (G) indicates a telephone directory; (H) shows a memorandum; (I) represents a profile; (J) shows a camera; (K) denotes a message; and (L) represents a history. Also, it is assumed that use times of the above-described function icons by the user are defined in this order from the symbols (A) to (L).

For example, FIG. 3(a) shows an arrangement as to priority levels of the respective cells and the function icons in such a case that a cell on a center of the 4×3 cells is defined as a top priority cell position. The function icon “A” whose use time made by the user is the largest use time is displayed on a cell of “priority level 1” corresponding to the top priority on the center. Next, upper/lower/right/left cell groups are set to “priority level 2”, which can be selected by moving the selection cursor one time from the cell on the center of the “priority level 1.” Also, cell groups are set to “priority level 3”, which can be selected by moving the selection cursor two times from the cell on the center of the “priority level 1.” Further, cell groups are set to “priority level 4”, which can be selected by moving the selection cursor three times from the cell on the center of the “priority level 1.”

Moreover, a right cell having the “priority level 1” among the cells having the “priority level 2” is set to a “priority level 2-a”, and the function icon (B) whose use time made by the user is the second largest use time is displayed on this right cell. Also, a left cell having the “priority level 1” is set to a “priority level 2-b”, and the function icon “(C)” whose use time made by the user is the third largest use time is displayed on this left cell. In order to select one of these function icons, considering now that the move key 115 is shift-operated by a thumb of a user, in the case of such a user having his favored right arm, either a right shift or a left shift corresponds to a position which may be subsequently and easily operated. As a result, these two places are assumed as second priority cell positions. In this embodiment mode, the right cell having the “priority level 1” is set. Alternatively, the left cell may be set to the “priority level 2-a”, and the right cell may be set to the “priority level 2-b.”

On the other hand, the lower cell of the “priority level 1” is set to a “priority level 2-c”, on which the function icon (D) whose use time made by the user is the fourth largest use time is displayed. Also, the upper cell of the “priority level 1” is set to a “priority level 2-d”, to which the function icon (E) whose use time made by the user is the fifth largest use time is displayed. In the case of such a user having a right favored arm, even in the cell groups having the same “priority level 2”, since “either lower shift or upper shift” is such a position which can be hardly operated, as compared with “either right shift or left shift”, priority levels of these two positions are set lower than those of the “priority levels 2-a and 2-b.” In this example, the lower cell having the “priority level 1” is set to the “priority level 2-c.” Alternatively, the upper cell may be set to the “priority level 2-c”, and the lower cell may be set to the “priority level 2-d.”

In addition, the lower cell of the “priority level 2-c” among the cells having the “priority level 3” is set to a “priority level 3-a”, on which the function icon (F) whose use time made by the user is the sixth largest use time is displayed. Also, the lower cell (namely, right cell having “priority level 2-c”) of the “priority level 2-a” is set to a “priority level 3-b” to which the function icon (G) whose use time made by the user is the seventh largest use time is displayed.

Moreover, the lower cell of the “priority level 2-b” (namely, left cell of “priority level 2-c”) is set to a “priority level 3-c), to which the function icon (H) whose use time made by the user is the eighth largest use time is displayed. Also, the upper cell of the “priority level 2-a” (namely, right cell of “priority level 2-d”) is set to a “priority level 3-d”, to which the function icon (I) whose use time made by the user is the ninth largest use time is displayed.

In addition, the upper cell of the “priority level 2-b” (namely, left cell having “priority level 2-d” is set to a “priority level 3-e”, on which the function icon (J) whose use time made by the user is the tenth largest use time is displayed. Also, the right cell (namely lower cell having “priority level 3-b”) of the priority level 3-a” is set to a “priority level 4-a”, to which the function icon (K) whose use time made by the user is the eleventh largest use time is displayed.

Moreover, the left cell of the “priority level 3-a” (namely, lower cell of “priority level 3-c”) is set to a “priority level 4-b), to which the function icon (L) whose use time made by the user is the 12th largest use time is displayed.

In the case of such a user having a right favored arm, since “either lower shift or upper shift” is such a position which can be hardly operated, as compared with “either right shift or left shift”, the above-described priority levels of these two positions are set. Alternatively, the cell positions as to the “priority level 3-b” and the “priority level 3-c” may be alternatively replaced with each other. Furthermore, the cell positions as to the “priority level 3-d” and the “priority level 3-e” may be substituted with each other.

Also, in correspondence with a user having a left favored arm, the arrangement as to the “priority level 3-d”, the “priority level 2-a”, the “priority level 3-b”, and the priority level 4-a” may be alternatively replaced by the arrangement as to the “priority level 3-e”, the “priority level 2-b”, the “priority level 3-c”, and the priority level 4-b.” Then, these priority level cell positions may be set to “positions for user having right favor arm”, or “positions for user having left favor arm”, which may be selected by a user.

Also, since 12 sorts of priority levels are provided, even when these priority levels are ordered in a similar manner to those of this drawing, as represented in FIG. 3(b), such priority levels all of which are different from each other may be alternatively set.

FIG. 3(c) shows an arrangement as to priority levels of the respective cells, and an arrangement as to the respective function icons in the case that an upper left cell within the 4×3 cells is set as a top priority cell having a top priority level, which is set especially for a user having a right favored arm. Then, the function icon “A” whose use time made by the user is the largest use time is displayed on a “priority level I” of the upper left top priority cell position. Next, a right cell group and a lower cell group which can be moved from the “priority level 1” by operating the cursor one time are set to “priority levels 2.” Such cell groups which can be moved from the “priority level 1” by operating the cursor two times are set to “priority levels 3.” Such cell groups which can be moved from the “priority level 1” by operating the cursor three times are set to “priority levels 4.” In addition, such cell groups which can be moved from the “priority level 1” by operating the cursor five times are set to “priority levels 5.” Also, such a cell group (in this case, 1 cell) which can be moved from the “priority level 1” by operating the cursor six times are set to “priority levels 6.”

Moreover, a right cell having the “priority level 1” among the cells having the “priority levels 2” is set to a “priority level 2-a,” on which the function icon (B) whose use time made by the user is the second largest use time is displayed. Also, a lower cell having the “priority level 1” is set to a “priority level 2-b”, on which the function icon (c) whose use time made by the user is the third largest use time is displayed. These “priority level 2-a” and “priority level 2-b” are defined as a second priority cell position. In this example, the right cell of the “priority level 1” is set to the “priority level 2-a.” Alternatively, the lower cell may be set to the “priority level 2-a”, and the right cell may be set to the “priority level 2-b.”

On the other hand, the lower cell of the “priority level 2-a” (namely, right cell of “priority level 2-b”) is set to a “priority level 3-a”, on which the function icon (D) whose use time made by the user is the fourth largest use time is displayed. Also, the right cell of the “priority level 2-a” is set to a “priority level 3-b”, on which the function icon (E) whose use time made by the user is the fifth largest use time is displayed. Also, the lower cell of the “priority level 2-b” is set to a “priority level 3-c”, on which the function icon (F) whose use time made by the user is the sixth largest use time is displayed. It should be understood that the cell positions as to the “priority level 3-b”, and the “priority level 3-c” may be alternatively replaced by each other.

Moreover, a lower cell having the “priority level 3-a” (namely, right cell having “priority level 3-c”) among the cells having the “priority level 4” is set to a “priority level 4-a”, on which the function icon (G) whose use time made by the user is the seventh largest use time is displayed. Also, right cell having the “priority level 3-a” is set to a “priority level 4-b”, on which the function icon (H) whose use time made by the user is the eighth largest use time is displayed. Also, the lower cell of the “priority level 3-c” is set to a “priority level 4-c”, on which the function icon (I) whose use time made by the user is the ninth largest use time is displayed. It should also be understood that the cell positions as to the “priority level 3-b”, and the “priority level 3-c” may be alternatively replaced by each other.

Then, the right cell of the “priority level 4-a” (namely, lower cell of “priority level 4-b”) among the cells of the “priority levels 4” is set to a “priority level 5a”, on which the function icon (J) whose use time made by the user is the tenth largest use time is displayed. Also, the lower cell of the “priority level 4-a” (namely, right cell of “priority level 4-c”) is set to a “priority level 5-b”, on which the function icon (K) whose use time made by the user is the eleventh largest use time is displayed. It should also be understood that the cell positions as to the “priority level 5-a”, and the “priority level 5-b” may be alternatively replaced by each other. Finally, the lower cell of the “priority level 5-a” (namely, right cell of “priority level 5-b”) is set to a “priority level 6”, on which the function icon (L) whose use time made by the user is the 12th largest use time is displayed.

FIG. 3(d) shows an arrangement as to priority levels of the respective cells, and an arrangement as to the respective function icons in the case that a left cell as to a center upper cell within the 4×3 cells is set as a top priority cell. The function icon (A) whose use time made by the user is the largest use time is displayed on the “priority level 1” corresponding to the top priority cell position of the center upper left position. Next, cell groups which can be moved from the cell having the “priority level 1” by operating the cursor one time are set to “priority levels 2”, and, cell groups which can be moved from the cell having the “priority level 1” by operating the cursor two times are set to “priority levels 3.” Also, cell groups which can be moved from the cell having the “priority level 1” by operating the cursor three times are set to “priority levels 4”, and a cell group (in this case, 1 cell group) which can be moved from the cell having the “priority level 1” by operating the cursor five times are set to “priority levels 5.” As to priority levels within the cell groups having the “priority levels 2”, a right cell having the “priority level 1” is set to a “priority level 2-a”, on which the function icon (B) whose use time made by the user is the second largest use time is displayed. Also, a lower cell of the “priority level 1” is set to a “priority level 2-b”, on which the function icon (C) whose use time made by the user is the third largest use time is displayed. Also, an upper cell of the “priority level 1” is set to a “priority level 2-c”, on which the function icon (D) whose use time made by the user is the fourth largest use time is displayed. These “priority level 2-a”, “priority level 2-b”, and “priority level 2-c” are assumed as second priority cell positions.

Moreover, a right cell having the “priority level 2-a” among the cells having the “priority level 3” is set to a “priority level 3-a”, on which the function icon (E) whose use time made by the user is the fifth largest use time is displayed. Also, a lower cell having the “priority level 2-a” (namely, right cell of “priority level 2-b”) is set to a “priority level 3-b”, on which the function icon (F) whose use time made by the user is the sixth largest use time is displayed. Also, an upper cell having the “priority level 2-a” (namely, right cell of “priority level 2-c”) is set to a “priority level 3-c”, on which the function icon (G) whose use time made by the user is the seventh largest use time is displayed. Then, a lower cell having the “priority level 2-b” is set to a “priority level 3-d”, on which the function (H) whose use time made by the user is the eighth largest use time is displayed.

Moreover, a lower cell having the “priority level 3-b” among the cells having the “priority level 4” is set to a “priority level 4-a”, on which the function icon (I) whose use time made by the user is the ninth largest use time is displayed. Also, a lower cell having the “priority level 3-a” (namely, right cell of “priority level 3-b”) is set to a “priority level 4-b”, on which the function icon (J) whose use time made by the user is the tenth largest use time is displayed. Then, an upper cell having the “priority level 3-a” is set to a “priority level 4-c”, on which the function icon (K) whose use time made by the user is the eleventh largest use time is displayed.

In addition, the function icon (L) whose use time made by the user is the 12th largest use time is displayed on a lower right cell having the “priority level 5.” Also, in FIG. 3(d), the priority levels of the respective cells may be changed in response to the user's dominant arm, and other conditions.

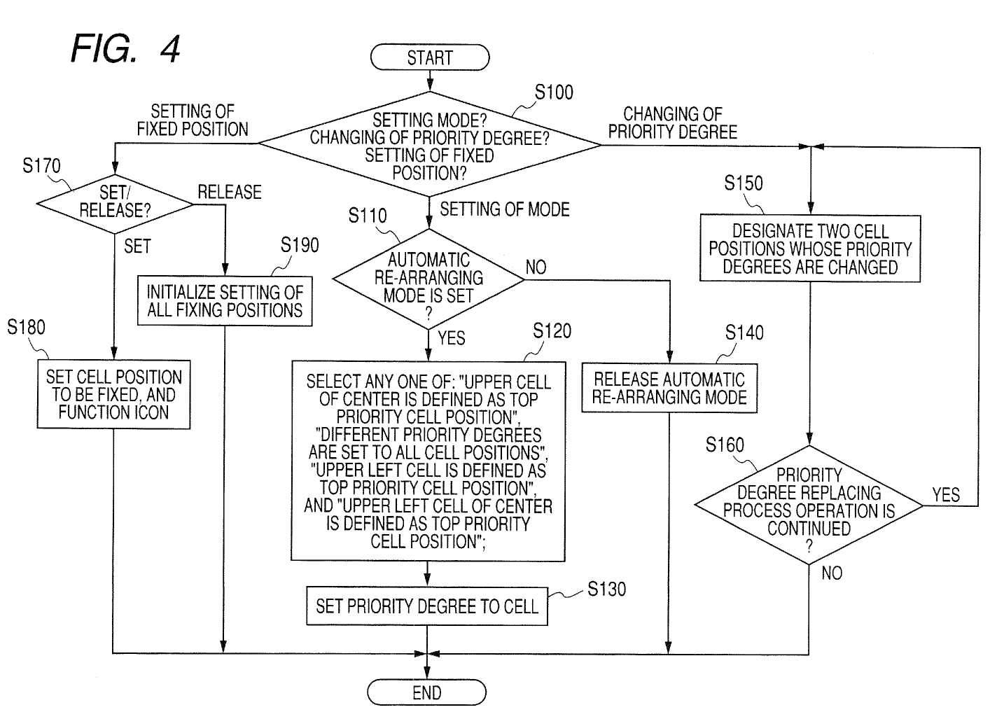

FIG. 4 is a flow chart for describing such a process operation that priority levels are set with respect to the respective cell positions formed in the matrix. Firstly, a selection is made of any one setting operation from “mode setting operation”, “changing/setting operation of priority level”, and “setting operation of fixed position” (step S100). When the “mode setting operation” is selected, a selection is made as to whether or not an automatic re-arranging mode is set. In the case that the automatic re-arranging mode is not set, the automatic re-arranging mode is released, and then, the process operation is accomplished (step S140). When the automatic re-arranging mode is set, a selection is made of any one of the following three setting operations: That is, “upper cell of center is set to top priority cell position”; “different priority levels are set to all cell positions”, “upper left cell is set to top priority cell position”; and “upper left cell of center is set to top priority cell position” (step S120). As a result, priority levels are automatically set with respect to the respective cells of the menu screen (S130). In such a case that “upper cell of center is set to top priority cell position” is selected, the priority levels of FIG. 3(a) are automatically set. Also, when “different priority levels are set to all of cell positions” is selected, the priority levels of FIG. 3(b) are automatically set. In such a case that “upper left cell is set to top priority cell position” is selected, the priority levels of FIG. 3(a) are automatically set. Furthermore, in such a case that “upper left cell of center is set to top priority cell position” is selected, the priority levels of FIG. 3(d) are automatically set.

On the other hand, when “priority levels are changed” is selected in the above-described step S100, two cell positions whose priority levels are wanted to be replaced with each other are entered so as to replace the priority levels with each other (step S150). In the case that the priority level replacing process operation is continuously performed, the replacing process operation is repeatedly carried out (step S160), and then, the process operation is accomplished. As a result, the present priority levels can be changed into such priority levels which are wanted by the user with respect to the respective cell positions.

On the other hand, in the case that “setting operation of fixed position” is selected in the previous step S100, a selection is subsequently made of either “setting” operation or “releasing” operation (step S170). When the “setting” operation is selected, both a cell position which is wanted to be fixed and a function icon which is wanted to be set are inputted, and then, the process operation is accomplished (step S180). On the other hand, when the “releasing” operation is selected, setting conditions related to all of the fixed positions are released to be returned to the initial condition (step S190). As a result, the function icon which is wanted by the user can be set to the top priority cell position, or the like in the fixed manner. It should also be understood that when the “setting operation of fixed position” is carried out, the control unit 104 performs priority level arranging process operation and priority level re-arranging process operation with respect to other function icons than the specific function icon which is fixed.

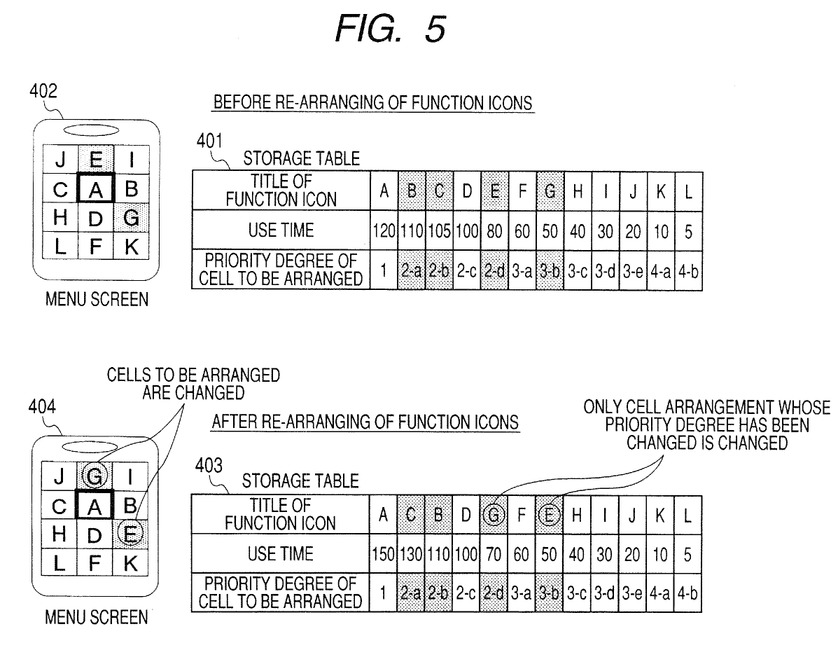

FIG. 5 is a diagram for showing one example as to re-arranging of function icons under such a condition that use times of the respective function icons (A) to (L) correspond to priority levels of cells of a menu screen. In this menu screen, the priority level setting operation is performed while the center cell is defined as the top priority cell position shown in FIG. 3(a); and a designation is made of a method for re-arranging function icons in response to use times of the function icons and priority levels of the cells by the control unit 114. It should also be noted that the below-mentioned storage table is provided in an area of the storage unit 110.

For instance, as shown in a storage table 401, the use times of the function icons (A) to (L) by the user are stored as 5 to 120 times respectively in the storage unit 110; and icon displays are carried out based upon the arrangement shown in the menu screen 402 in accordance with the top priority level cell position represented in FIG. 3(a).

It is so assumed that in the arrangement of the menu screen 402, every time the respective function icons are selected by the user, the use times made by the user as to the corresponding function icons are updated (namely, are counted up); and after the function icons are used for a predetermined time period, storage contents of another storage table 403 are changed as to the respective function icons. In this case, re-arranging operation of these function icons is carried out as indicated in another menu screen 404 by the control unit 114. In other words, since the use times made by the user as to the function icons “B”, “C”, “E”, and “G” of the storage table 401 are changed, a priority level of such a cell where the function icon “B” is arranged is changed from the position of “priority level 2-a” into the position of “priority level 2-b”, and in connection thereto, the function icon “C” is changed from the position of “priority level 2-b” into the position of “priority level 2-a.” Also, the function icon “E” is changed from the position of “priority level 2-d” into the position of “priority level 3-b”, and in connection thereto, the function icon “G” is changed from the position of “priority level 3-b” into the position of “priority level 2-d.” At this time, even when the use times made by the user are changed, as to the function icons “B” and “C” whose priority levels does not change, the positions thereof are not changed, whereas as to the function icons “E” and “G” whose priority levels are changed into “priority level 3” and “priority level 2”, the positions thereof are re-arranged. In this case, only such function icons whose priority levels are changed are not re-arranged, but the arrangement of the priority level cells indicated in FIG. 3(b) is set to the menu screen, so that all of the function icons whose use time order is changed in accordance with the use times of the function icons may be alternatively re-arranged.

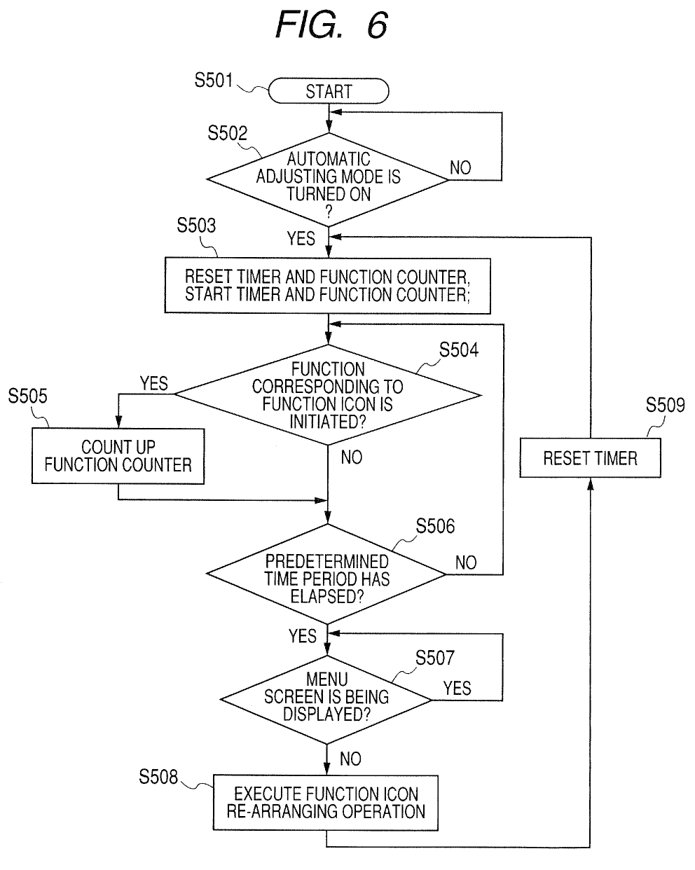

FIG. 6 is a flow chart for describing control operations as to the menu screen 104, in accordance with the present embodiment mode of the present invention.

When a main power supply (not shown) of a mobile communication apparatus is turned ON, the mobile communication apparatus is brought into an operation starting condition (step S501). The control unit 114 refers to the storage unit 110 so as to judge whether an automatic adjusting mode is turned ON, or OFF (step S502). The automatic adjusting mode corresponds to such a mode that function icons are re-arranged by the control unit 114. When the automatic adjusting mode is turned OFF, the control unit 114 continuously judges a status of the automatic adjusting mode. When the automatic adjusting mode is turned ON, the control unit 114 initializes the timer of the timer unit 113 so as to initialize used times (function counters) of the respective function icons (A) to (L) stored in the storage unit 110. Then, the control unit 114 performs a control operation for commencing the timer and counting operations as to the use times of the respective function icons (A) to (L) (step S503).

In this case, the control unit 114 continuously monitors whether or not the keyboard 108 is manipulated by the user; a function corresponding to a function icon to be displayed on the menu screen 104 is selected, and then, the selected function is initiated (step S504).

When the function corresponding to any one of the function icons is selected and initiated, the control unit 114 counts up the use time of this function icon stored in the storage unit 110 (namely, table 401 shown in FIG. 4) in a step S505, and thereafter, judges whether or not a predetermined time period elapsed by the timer (step S506).

When the predetermined time period did not elapse, the control operation is again returned to the step S504. Every time a function icon is initiated, the control unit 114 repeatedly executes the process operation of the step S505 until the predetermined time period elapsed.

Then, in such a case that the predetermined time period elapsed, the control unit 114 judges whether or not the menu screen 104 is displayed on the display unit 105 (step S507). When the menu screen 104 is being displayed on the display unit 105, the control unit 114 does not re-arrange the function icons of the menu screen 104 in accordance with the storage table, but is brought into a waiting condition until the present screen display is transferred to another screen display.

In such a case that the control unit 114 judges that a screen except for the menu screen 104 is being displayed, the control unit 114 refers to the storage table (namely, table 403 of FIG. 5) stored in the storage unit 110 so as to re-arrange the function icons. In other words, the control unit 114 sequentially allocates the function icons in this order from the function icons whose use times made by the user are larger to the cells having the higher priority levels in order to change the arrangement of the function icons (step S508). After the re-arrangement of the function icons defined in the step S508 is executed, the control unit 114 resets the timer (step S509), and then, the process operation is returned to the step S504. It should also be noted that in this embodiment mode, if the main power supply is turned OFF, then the process operation is brought into the operation accomplish condition in any time (not shown).

Also, the priority orders are previously set to the respective function icons, so that the priority orders can be defined with respect to such function icons whose use times made by the user are equal to each other. In addition, while time durations (used time durations) during which function icons are actually used are measured by the timer unit 113, in such a case that there are such function icons whose use times made by the user are equal to each other, the priority order for the function icon having the longer used time duration may be alternatively set to be high.

In accordance with the present invention, in the mobile communication apparatus in which the plurality of function icons are arranged in the matrix form, the layout as to the plural function icons is changed based upon the use times made by the user, and the priority levels set to the cells of the menu screen. As a result, such function icons whose use times made by the user are large can be simply arranged at the positions where these icons can be easily used by the user, and thus, the operation for selecting the various sorts of functions can become convenient for the user. Moreover, in the structure of the present embodiment mode, when the function icons are re-arranged, only such function icons whose priority levels are changed are re-arranged. As a consequence, the frequencies at which the function icons are re-arranged may be slightly lowered, so that the user can easily recognize the positions of the function icons.

It should also be understood that the present embodiment modes may be properly changed, or combined with each other within such a range without departing from the gist of the present invention. Also, the arrangement of the plurality of function icons is not limited only to such a matrix-shaped function icons arrangement made of 4×3 cells, but may be applied to other shapes such as 3×3 cells, 5×3 cells, and so on.

As described with reference to the embodiment, there is provided a communication apparatus having a matrix-shaped menu screen, function icons whose use times made by a user are large can be simply re-arranged at desirable arranging positions, since priority levels for determining priority orders for arranging function icons are set to cells of the menu screen, which are arranged in the matrix form, and thereafter, such function icons whose use times made by the user are large are arranged in response to priority levels of cells.

As described with reference to the embodiment, there is provided the mobile communication apparatus having the menu screen formed in the matrix, with respect to the arrangement of the function icons, the layout thereof is changed based upon the use times of the function icons made by the user and the priority levels of the cells of the menu screen. As a result, the function icons can be simply arranged to such positions that the arranged function icons can be easily used by the user.

What is claimed is:

1. A mobile communication apparatus comprising:
a display unit that displays a menu screen on which a plurality of icons are arranged as cells in a matrix;
an input unit configured to operate a cursor for selecting at least one of the icons;
a storage unit that stores priority levels of respective cells, the priority levels indicating priority for assigning the icons into the cells; and
a control unit that re-assigns the icons to the cells in order of the priority levels according to the number of selecting operations for the respective icons.

2. A mobile communication apparatus comprising:
a display unit that displays a menu screen on which a plurality of icons are arranged as cells in a matrix;
an input unit configured to operate a cursor for selecting at least one of the icons;
a storage unit that stores priority levels of respective cells, the priority levels indicating priority for assigning each icon and the priority levels allowing an identical priority level to two or more of the cells; and
a control unit configured to sort the icons in order of the number of operations for selecting the icons to re-assign the icons to the cells in accordance with the priority levels of the cells,
wherein the control unit rearranges positions of the icons that are re-assigned to the cells having different priority from the cells previously assigned.

3. The mobile communication apparatus according to claim 1, wherein the control unit automatically set the priority levels of all of the cells by setting a position of a cell having a highest priority level.

4. The mobile communication apparatus according to claim 3, wherein the control unit set the priority levels of the cells in accordance with times of moving of the cursor from the position of the cell having the highest priority level to icons to be selected.

5. The mobile communication apparatus according to claim 1, wherein the control unit set the priority levels of the cells in accordance with times of moving of the cursor from an initial position to icons to be selected.

6. The mobile communication apparatus according to claim 1, wherein the control unit re-assigns the icons to the cells at certain time intervals.

7. The mobile communication apparatus according to claim 1, wherein the control unit re-assigns the icons to the cells when the display unit displays a screen other than the menu screen.

8. The mobile communication apparatus according to claim 2, wherein the control unit automatically set the priority levels of all of the cells by setting a position of a cell having a highest priority level.

9. The mobile communication apparatus according to claim 8, wherein the control unit set the priority levels of the cells in accordance with times of moving of the cursor from the position of the cell having the highest priority level to icons to be selected.

10. The mobile communication apparatus according to claim 2, wherein the control unit set the priority levels of the cells in accordance with times of moving of the cursor from an initial position to icons to be selected.

11. The mobile communication apparatus according to claim 2, wherein the control unit re-assigns the icons to the cells at certain time intervals.

12. The mobile communication apparatus according to claim 2, wherein the control unit re-assigns the icons to the cells when the display unit displays a screen other than the menu screen.
